(19) United States
(12) Patent Application Publication
(10) Pub. No.: US 2006/0114212 A1
(43) Pub. Date: Jun. 1, 2006

(54) Buffer circuit

(76) Inventor: Koji Hirosawa, Ichinomiya-shi (JP)

Correspondence Address: CANTOR COLBURN, LLP, 55 GRIFFIN ROAD SOUTH, BLOOMFIELD, CT, 06002, US

(21) Appl. No.: 11/287,899

(22) Filed: Nov. 28, 2005

(30) Foreign Application Priority Data
Nov. 29, 2004 (JP) 2004-344981

(51) Int. Cl. G09G 3/36

(52) U.S. Cl. 345/98

(57) ABSTRACT

A pair of complementary clock signals are output from a level shifter, and input to first and second buffer circuits. The first and second buffer circuits are each formed of a plurality of inverters. An inverter in a first stage of one buffer circuit is provided close to the level shifter, followed by arrangement of an inverter in a first stage of the other buffer circuit.

### CROSS-REFERENCE TO RELATED APPLICATIONS

The entire disclosure of Japanese Patent Application No. 2004-344981 including specification, claims, drawings, and abstract is incorporated herein by reference.

### BACKGROUND OF THE INVENTION

1. Field of the Invention

The present invention relates to a buffer circuit disposed in a peripheral section of a display panel, and used for stabilizing a complementary pair of pulse signals having an increased amplitude output from a level shifter and providing the signals as horizontal transfer clocks in the display panel.

2. Description of the Related Art

Flat displays having a multitude of pixels on a single substrate, such as LCDs and organic EL displays, are in wide use. Flat displays include active matrix type panels having a selection transistor disposed for each of the pixels arranged in a matrix for controlling display at each pixel; panels of this type are suitable for high resolution display.

In order to supply a video signal to be displayed to each of the two-dimensional pixels, such an active matrix type panel requires a vertical driver for shifting a display line in a vertical direction, and a horizontal driver for sequentially supplying a video signal to each pixel in a horizontal direction.

In the horizontal driver, an H level strobe signal indicating initiation of one horizontal period is taken into a horizontal shift register, and transferred in accordance with a horizontal transfer clock.

The horizontal transfer clock is synchronized with the video signal, so that a switch between a video signal line and a data line provided for each column of the panel is opened by output of the horizontal shift register, thereby supplying a data signal for each pixel to the corresponding data line.

On the other hand, in the vertical driver circuit, a pixel in a row of the panel to which the data signal must be supplied is selected, so that the data signal for each pixel can be supplied thereto.

Because the data signal is supplied to the data line through a switch, degradation of the signal at the switch must be avoided in order to display a clear image. As a result, a sufficiently large signal must be output from the horizontal shift register, and therefore the horizontal transfer clock must be provided with a large amplitude. In consideration of this requirement, in commonly-used panels the amplitude of the horizontal transfer clock synchronized with the video signal is increased by a level shifter, and output of the level shifter is provided with a sufficiently high current capability and stabilized by a buffer circuit formed by a plurality of inverters connected in series.

Such a buffer circuit is used for transmitting the horizontal transfer clock having a large amplitude and a high frequency, and consumes a relatively large amount of electric power and generates a large amount of heat. If such a large amount of heat generated by the buffer circuit significantly increases the temperature of the surrounding components, the display section can also be affected as an increased temperature can affect the properties of transistors and liquid crystal, thereby lowering an image quality.

In consideration of this problem, in conventional panels inverters in the buffer circuit are arranged at a wider interval in a distributed (scattered) manner to suppress heat elevation.

However, when the buffer circuit is configured in a distributed manner, the load of a line is increased, and delay time at this spot is prolonged. As a result, synchronization between the video signal and the vertical transfer clock may not be sufficiently achieved, which may lead to a poor image quality.

### SUMMARY OF THE INVENTION

The present invention provides a buffer circuit disposed in a peripheral section of a display panel for stabilizing a complementary pair of pulse signals having an increased amplitude output from a level shifter and supplying the signals as horizontal transfer clocks in the display panel, including a first buffer circuit formed by a plurality of inverters connected in series, and stabilizing one output of the level shifter, and a second buffer circuit formed by a plurality of inverters connected in series, and stabilizing the other output of the level shifter, wherein a combination of the first and second buffer circuits is arranged in a substantially linear manner in the peripheral section of the display panel, and the plurality of inverters of one of the first and second buffer circuits are arranged in a divisional manner sandwiching the plurality of inverters forming the other buffer circuit.

According to the present invention, an amount of delay in the pair of buffer circuits can be reduced to a relatively small value, thereby effectively preventing missynchronization. Particularly by reducing the distance to the inverter in the first stage of the buffer circuit, the amount of delay can be effectively reduced. The amount of generated heat can also be reduced by employing a counter electrode AC driving method, thereby achieving a space-saving arrangement with a small amount of delay.

### BRIEF DESCRIPTION OF THE DRAWINGS

FIG. 1 shows an example configuration of a buffer circuit.

FIG. 2 shows the position where the buffer circuit is arranged in a panel.

FIG. 3 shows a configuration of a CMOS transistor.

FIG. 4 shows a cross sectional configuration of the CMOS transistor.

### DESCRIPTION OF PREFERRED EMBODIMENTS

A preferred embodiment of the present invention will now be described with reference to the accompanying drawings.

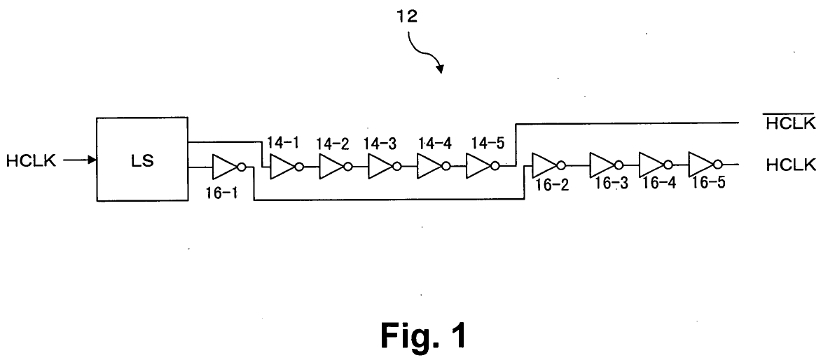

FIG. 1 shows configuration and arrangement of a level shifter buffer circuit according to the present embodiment. A level shifter LS increases an amplitude of a horizontal transfer clock HCLK corresponding to a data voltage for each pixel of a video signal applied from an external LSI or the like, converting a signal of, for example, approximately 0-3 V to a voltage of approximately 0-15 V. This can easily be achieved by connecting a power source voltage of 15 V in a display panel to an output end when the supplied horizontal transfer clock HCLK attains either an H level or an L level.

While the voltage of an output of the level shifter LS is raised, the current capability thereof is small. Consequently, a plurality of inverters are connected in series, so that the output is stabilized with a sufficient current capability after going through the inverters while maintaining the voltage.

The level shifter LS supplies a pair of clocks (HCLK, /\overline{HCLK}) having phases inverted from each other as the horizontal transfer clocks HCLK. A level shifter buffer 12 includes five inverters 14-1 to 14-5 for one clock/\overline{HCLK}, and five inverters 16-1 to 16-5 for the other clock HCLK.

Because these ten inverters are arranged in a peripheral section of the display panel, they are arranged in a basically linear manner. The inverter 16-1 for one clock is disposed in proximity to the level shifter LS, followed by the inverters 14-1 to 14-5, and the inverters 16-2 to 16-5.

In other words, the inverter 16-1 is disposed very close to the level shifter LS, and the inverter 14-1 is arranged next thereto. Consequently, the wiring line from the level shifter LS to the inverter 14-1 runs beside the inverter 16-1. The inverters 14-1 to 14-5 are disposed in succession. Next to the inverter 14-5, the inverters 16-2 to 16-5 are arranged. The wiring line from the inverter 16-1 to the inverter 16-2 runs beside the inverters 14-1 to 14-5. The wiring line from the inverter 14-5 to the horizontal driver runs beside the inverters 16-2 to 16-5. The wiring line from the inverter 16-5 to the horizontal driver runs directly from the inverter 16-5.

According to the present embodiment, these two inverters 14-1 and 16-2 are arranged relatively close to the level shifter LS, and the wiring lines thereto are short. Consequently, operation delay of the inverters 14-1 and 16-2 can be reduced to a relatively small level, whereby a difference between the synchronized horizontal transfer clock and video signal (deviation in data voltage sampling timing) can be reduced to prevent a decline in image quality. Further, because all the inverters can be disposed in a substantially linear manner, the width of the region where the inverters are disposed can be reduced, thereby achieving a display panel having a narrower frame, i.e. a smaller peripheral area surrounding a display region.

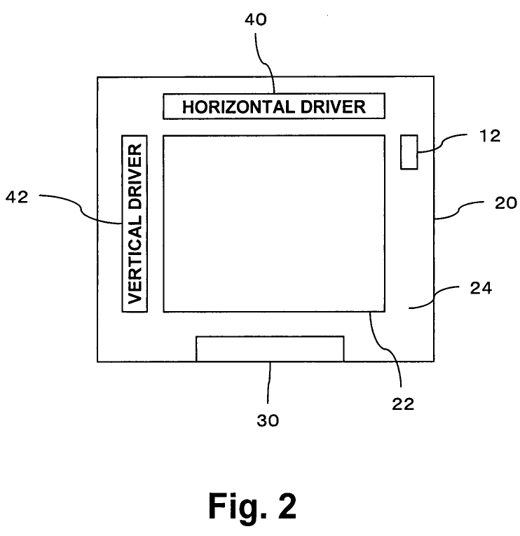

FIG. 2 shows the arrangement of the level shifter LS and the level shifter buffer 12 on the display panel. The display panel according to the present embodiment is a liquid crystal display panel. The liquid crystal display panel is formed by a TFT substrate and an opposite substrate. A TFT substrate 20 includes a display region 22 occupying a major inner portion thereof. The region 22 includes for each pixel a switching TFT, a storage capacitor, and a pixel electrode, and is surrounded by a peripheral region 24 where a variety of signal processing circuits (peripheral circuits) are disposed. Meanwhile, on the opposite substrate, an opposite electrode facing the pixel electrode with liquid crystal in between is disposed to be shared by all the pixels.

On one side of the TFT substrate 20, a connector section 30 is formed. The connector section 30 is connected to a flexible wiring line from an external source, and receives various signals and electric power supplied thereto. Wiring lines are drawn from the connector section 30, including a line connected to the level shifter LS. In this example, the level shifter LS is disposed in the right middle section of the TFT substrate 20 in the figure, and the level shifter buffer 12 is disposed above the level shifter LS in the figure.

Output of the level shifter buffer 12 is supplied to a horizontal driver 40 disposed above the display region 22 in the figure. The horizontal driver 40 controls supply of the data voltage to each pixel of the display region. More specifically, pixels are arranged in a matrix in the display region 22, a vertical data line is disposed for each column of the pixels, and a horizontal gate line is disposed for each row thereof. The horizontal driver 40 controls so that the data signal is supplied to the corresponding data line.

On the left side of the display region 22 in the figure, a vertical driver 42 is disposed for controlling selection of the gate line.

In such a liquid crystal panel, display at each pixel is achieved by applying a voltage in accordance with the data voltage between the pixel electrode and the opposite electrode. Applying the voltage to the liquid crystal constantly in a fixed direction degrades the liquid crystal. Therefore, the direction of the data voltage applied to the liquid crystal is inverted on, for example, the dot-by-dot, line-by-line, or field-by-field basis.

Such inversion is achieved by a counter electrode AC driving method or a counter electrode DC driving method. In the counter electrode AC driving method, a voltage of the opposite electrode is periodically inverted around a predetermined voltage, and the data voltage is supplied as an inner difference voltage with respect to the inverted voltage of the opposite electrode. Accordingly, the periodically inverted data voltage is applied to the liquid crystal. In the counter electrode AC driving method, all the voltages may be in the range of the two inverted voltages of the opposite electrode. Therefore, the voltage width necessary for a power source voltage can be suppressed within a relatively small range.

On the other hand, in the counter electrode DC driving method, the opposite electrode is fixed to a predetermined voltage, and the data voltage is inverted in a fixed cycle with respect to the fixed opposite electrode voltage. Although the configuration is simple because the potential of the opposite electrode is fixed, the amplitude twice the dynamic range of the data voltage must be handled by the power source, resulting in a larger booster circuit and a higher power consumption.

Therefore, the counter electrode AC driving method is used in the present embodiment. In the counter electrode DC driving method, the power source voltage of approximately 16 V is required to apply a voltage of 8 V to the liquid crystal. On the other hand, only the voltage of approximately 8 V is required in the counter electrode AC driving method. It should be noted that the figures are simply based on theoretical calculation, and that power source voltages of 15.5 V or 8.5 V are necessary to secure the dynamic range of approximately 5 V in the counter electrode DC or AC driving method, respectively.

By thus changing from the counter electrode DC driving method to the counter electrode AC driving method, the power source voltage can be reduced to nearly half, from 15.5 V to 8.5 V. Because the amount of consumed electric power is proportional to the voltage squared, the amount of generated heat can be reduced to approximately 30% by employing the counter electrode AC driving method.

Such a reduction in the amount of generated heat makes it possible to arrange the inverters of the level shifter buffer 12 relatively close to one another, thereby decreasing the load on the transferred clock, and therefore lowering the probability of display error caused by delay of the clock. As a result, display panel manufacturing yield can be increased.

Table 1 shows the display panel size (display size), the power source voltage (V), the electric power (mV) consumed by a single inverter in the last stage of the level shifter buffer 12, the size w (μm) of the inverter in the last stage, and the area of the inverter in the last stage based on the provisional standard in view of the consumed power.

TABLE 1

| | | | | | DISTRIBUTED |
|---|---|---|---|---|---|
| | | | | | AREA OF THE |
| | | POWER | CONSUMED | LAST | LAST STAGE |
| | PANEL | SOURCE | ELECTRIC | STAGE | (PROVISIONAL |
| | SIZE | VOLTAGE | POWER | BUFFER | DEFINITION |
| | (INCH) | (V) | (Mw) | (μm) | (μm) |
| COUNTER | 3.5 | 15.5 | 232.5 | 1,800/3,600 | 12,000 |
| ELECTRODE | | | | | |
| DC | | | | | |
| COUNTER | 2.0 | 8.5 | 38.3 | 1,200/1,800 | 1,913 |
| ELECTRODE | | | | | |
| AC | | | | | |
| COUNTER | 2.5 | 8.5 | 47.6 | 1,900/1,900 | 2,380 |
| ELECTRODE | | | | | |
| AC | | | | | |
| COUNTER | 2.0 | 8.5 | 25.5 | 540/1,080 | 1,275 |
| ELECTRODE | | | | | |
| AC | | | | | |
| COUNTER | 1.5 | 8.5 | 17.0 | 540/810 | 850 |
| ELECTRODE | | | | | |
| AC | | | | | |

When the counter electrode DC driving method is used for a 3.5 inch display, the power source voltage is 15.5 V, the consumed electric power is 232.5 mW, the gate length of an n-channel transistor is 1800 μm, the gate length of a p-channel transistor is 3600 μm, and the provisional area of the inverter in the last stage is 12000 μm. The inverter in the last stage is preferably formed of a plurality of CMOS transistors. More specifically, an inverter formed of a single n-channel or p-channel transistor requires a significant width in order to ensure a sufficient gate width w thereof. On the other hand, if the inverter consists of a plurality of transistors connected in parallel, the required width can be reduced, and these transistors can function as a single inverter.

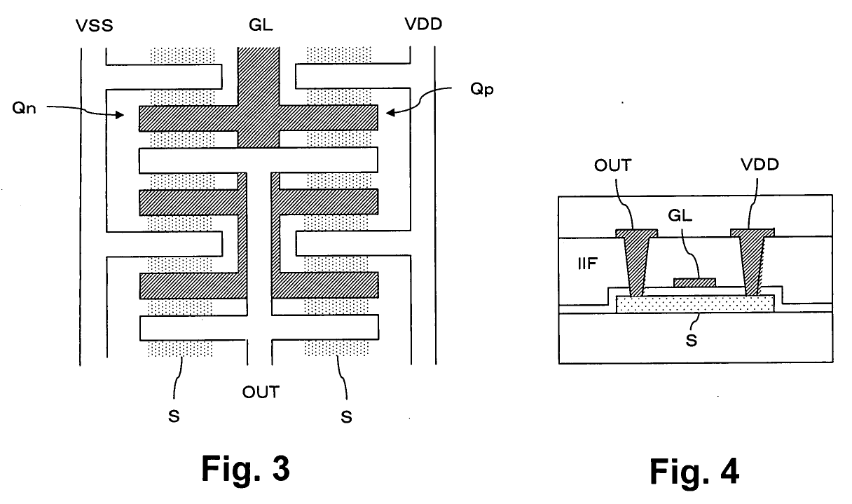

FIG. 3 shows such a configuration, in which a power source line VSS at a low voltage is arranged on one end, and a power source line VDD at a high voltage is arranged on the other end. A gate line GL and an output line OUT are arranged in between.

A p-channel transistor Qp is formed between the power source line VDD and the gate line GL, while an n-channel transistor Qn is formed between the gate line GL and the power source line VSS.

The p-channel transistor Qp is formed by a source electrode extending from the power source line VDD, a drain electrode extending from the output line OUT, a gate electrode extending from the gate line, and one semiconductor layer S disposed below these electrodes. The semiconductor layer S includes a source region connected to the bottom of the source electrode through a contact and doped with impurities, a channel region disposed below the gate electrode with a gate insulating film in between and having no impurities doped thereto, and a drain region connected to the bottom of the drain electrode through a contact and doped with impurities.

The n-channel transistor Qn has a substantially similar configuration, and formed by a drain electrode extending from the output line OUT, a source electrode extending from the power source line VSS, a gate electrode extending from the gate line GL, and one semiconductor layer S located below these electrodes.

Although only two stages of CMOS transistors are shown in the figure, in an actual device approximately 40 CMOS transistors described above are formed in the vertical direction of the figure. Referring to FIG. 4, the gate line GL is disposed below the layers of the power source lines VDD and VSS, and the source and drain electrodes with an interlayer insulating film IIF in between, so that the output line OUT can be disposed above the gate line GL. As a result, the plurality of CMOS transistors can easily be connected in parallel.

Here, if the gate width of a single n-channel transistor is 50 μm, the total gate width will be 2000 μm. This gate width is determined by such factors as the number of inverters provided and the amount of current required for driving a load (the shift transistor of the horizontal driver), as shown in Table 1 as an example. While a wider distance between the power source lines VDD and VSS enables to provide a greater gate width for a single transistor, it also results in a wider width of the inverter in the horizontal direction. In order to achieve a display panel with a narrow frame, the width of the inverter in the horizontal direction must be minimized, whereby a relatively large number of transistors must be provided.

Judging from results of experiments of the counter electrode DC driving method on a panel, an area of approximately 12000 μm is necessary for the distributed region (arrangement region) of about 20 CMOS transistors in the last-stage inverter. In other words, the distributed region of 12000 μm/232.5 mW, i.e. an area of approximately 50 μm/mW is required.

Thus, it is found that, in designing the device, the minimum area of the distributed region with respect to a certain amount of generated heat can be determined through an experiment or the like, and for other panels the area of the distributed region can be determined in accordance with the amount of generated heat.

What is claimed is:

1. A buffer circuit disposed in a peripheral section of a display panel for stabilizing a complementary pair of pulse signals having an increased amplitude output from a level shifter and supplying the signals as horizontal transfer clocks in the display panel, comprising:
a first buffer circuit formed by a plurality of inverters connected in series, and stabilizing one output of the level shifter; and
a second buffer circuit formed by a plurality of inverters connected in series, and stabilizing the other output of the level shifter; wherein
a combination of the first and second buffer circuits is arranged in a substantially linear manner in the peripheral section of the display panel, and the plurality of inverters of one of the first and second buffer circuits are arranged in a divisional manner sandwiching the plurality of inverters forming the other buffer circuit.

2. A buffer circuit according to claim 1, wherein
a first inverter of said one buffer circuit is arranged next to a first inverter of said other buffer circuit, and the first inverters of the two buffer circuits are arranged close to the level shifter.

3. A buffer circuit according to claim 1, wherein
the display panel is a liquid crystal panel, in which each pixel includes a switching element for controlling intake of a data voltage, a capacitor storing and applying to liquid crystal the voltage taken therein, and a pixel electrode connected to the capacitor, and applies a voltage in accordance with a potential of the pixel electrode to the liquid crystal located between the pixel electrode and an opposite electrode, and
a voltage of the opposite electrode is periodically inverted around a predetermined voltage, and the data voltage is supplied as an inner difference voltage with respect to the inverted voltage of the opposite electrode, thereby applying the data voltage to the liquid crystal while inverting the direction thereof to achieve a counter electrode AC driving method.
